(19) United States
(12) Patent Application Publication
(10) Pub. No.: US 2006/0151537 A1
(43) Pub. Date: Jul. 13, 2006

(54) Insulating system and container for storing and dispensing liquid material

(76) Inventor: Dean Carroll, Georgetown, TX (US)

Correspondence Address: WINSTEAD SECHREST & MINICK P.C., PO BOX 50784, DALLAS, TX, 75201, US

(21) Appl. No.: 11/328,549

(22) Filed: Jan. 10, 2006

Related U.S. Application Data
(60) Provisional application No. 60/642,703, filed on Jan. 10, 2005.

(51) Int. Cl. B67D 5/06

(52) U.S. Cl. 222/183; 222/185.1

(57) ABSTRACT

A system for storing and dispensing liquid materials includes a container base, a removable closure for loading the container unit, and a spout valve on the closure and/or on the container body. The container unit provides a sealable large opening that allows the liquid material to be easily loaded into the container unit for storage. The closure seals and is easily removed facilitating cleaning of the container unit. The spout valve on the closure allows controlled dispensing of the stored liquid material. An insulation system is provide to adapt the system for thermally sensitive liquid materials. Additionally a brace unit supports the container unit in a desired dispensing angle to maximize the rate of liquid material removal and prevent the container unit from moving during dispensing.

### PRIORITY BENEFIT AND CROSS REFERENCE TO RELATED APPLICATIONS

This application is related to the following commonly owned co-pending U.S. patent application:

Provisional Application Ser. No. 60/642,703, entitled “Container Unit for Storing and Dispensing Liquid Material”, filed Jan. 10, 2005, and claims the benefit of its earlier filing date under 35 U.S.C. §119(e).

### TECHNICAL FIELD

The present invention relates in general to containers used to store and dispense liquid materials.

### BACKGROUND INFORMATION

Throughout human history containers have played a critical roll in the storage and transportation of liquid materials. The variety is endless. In most applications, features added to the basic concept of a container is what creates a more useful container.

There are many applications that utilize a container that hold liquid material. When liquid material is being removed from the container, it is useful to have the control for dispensing stored liquid material conveniently located. For example, a container with liquid is far more useable when there is some exit point that will dispense the liquid in a small stream with a control for adjusting the rate from full flow to complete shutoff. To better utilize the dispensing of liquid, a device for holding the container at an appropriate dispensing angle is also needed. The appropriate dispensing angle may hold the container in an orientation significantly different from its orientation when simply storing liquid material. As some liquid materials are temperature sensitive, it would add utility to also have a means of insulating the container.

There is, therefore, a need for an insulated container unit that has a means for dispensing and controlling the flow of stored liquid material. Further, there is a need to control the flow of the liquid material when dispensing, while having a removable and sealable larger opening that allows easy access for filling, emptying, cleaning, etc.

### SUMMARY OF THE INVENTION

A system for storing and dispensing liquid comprises a dispensing container that has a large removable closure that seals the container when in place. The removable closure has a dispensing opening with a spout valve to control the flow of a stored liquid material so that the liquid material is dispensed in a controlled manner. In one embodiment, the removable closure has a second smaller opening for applications where filling the container requires other than the large opening. In another embodiment, a removable insulating sleeve fits over the container unit when it is used to store and dispense thermally sensitive liquid material. In yet another embodiment, a brace apparatus is configured to conform to the outside surface of the container and hold the container unit in a desired dispensing angle for gravity feed.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembly drawing showing the components a container unit according to embodiments of the present invention;

FIG. 2 is an assembly drawing of an embodiment of the closure with no secondary opening and with a spout valve according to embodiments of the present invention;

FIG. 3 is an assembly drawing showing the closure of FIG. 1 fully assembled;

FIG. 4 is a drawing of an embodiment of the container unit with an insulating sleeve; and

FIG. 5 is a drawing of the container unit in a dispensing orientation using a brace according to embodiments of the present invention.

### DETAILED DESCRIPTION

In the following description, numerous specific details are set forth to provide a thorough understanding of the present invention. However, it will be obvious to those skilled in the art that the present invention may be practiced without such specific details. In other instances, well-known elements may be shown in block diagram form in order not to obscure the present invention in unnecessary detail. For the most part, details concerning detailed dimensions and the like have been omitted inasmuch as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views. The following refers to the invention as dispensing liquid material for simplicity. It is understood that the present invention may be used to dispense materials that exhibit the flow characteristics such as fine powers and granulated materials and is not limited to liquid materials.

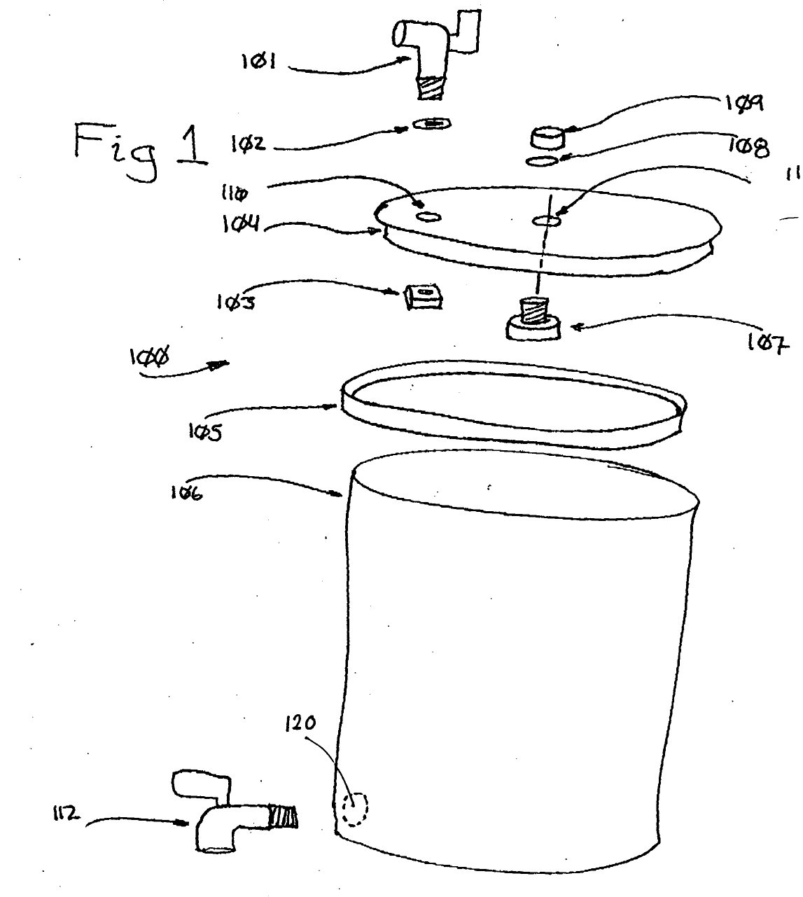

FIG. 1 illustrates the assemble of dispensing container unit 100 according to embodiment of the present invention. The dispensing container unit 100 comprises a container body 106, an adapting ring 105, a closure 104, a spout valve 101, washer 102 and retaining nut 103. A secondary opening 111 is shown through closure 104 that may or may not be need in some applications. In those applications where the secondary opening 111 is used, an insert 107 is inserted through the secondary opening 111 and coupled to closure 104 (e.g., bonded). In this embodiment, insert 107 is hollow and threaded. Cap element 109 is also threaded and provides a way of sealing secondary opening 111 from the outside when washer 108 is seated by screwing on threaded cap element 109. Sealing optional secondary opening 111 by other means is possible and is considered within the scope of the present invention. Spout valve 101 is inserted through hole 110 and seats through sealing gasket 102 in closure 104 when it is screwed into retainer nut 103. Spout valve 101 could also be placed on container body 106 as illustrated with spout valve 112 as an optional location. A spout valve 112 would interface through opening 120 which is shown dotted as optional. Typically only one location for the spout valve would be used (e.g., spout valve 101 or spout valve 112), however, the present invention is not limited to using only one spout valve. Spout valves 101 and 112 may be self-vented to prevent chugging, however, it is understood that embodiments of the present invention are not limited to self-vented spout valves.

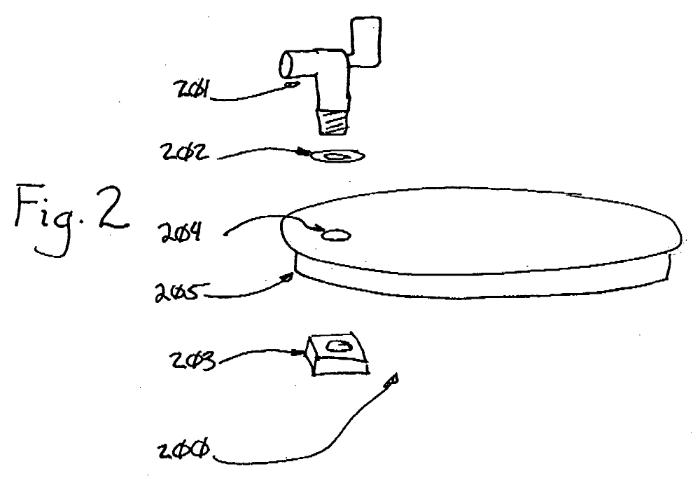

FIG. 2 illustrates a closure 200 according to embodiments of the present invention that has no optional secondary opening (e.g., 111) or closure elements (e.g., 107-109). Spout valve 201 is inserted into opening 204 in closure 205 and seats through sealing gasket 202 when screwed into threaded retainer nut 203. Spout valve 201 may be self-vented to prevent chugging, however, it is understood that embodiments of the present invention are not limited to self-vented spout valves.

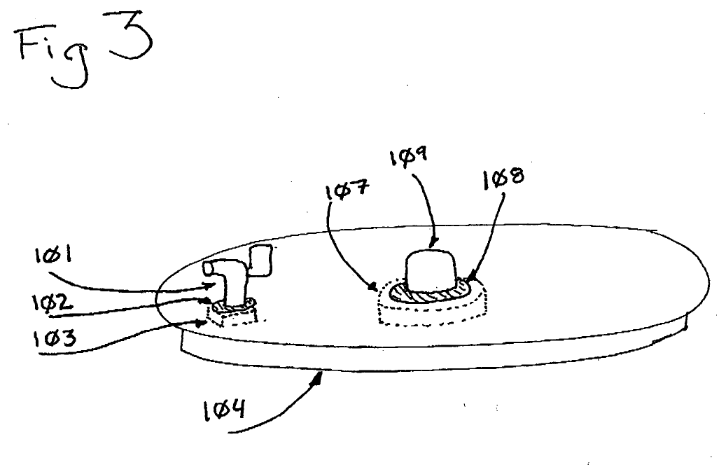

In FIG. 3 illustrates a closure 104 fully assembled with spout valve 101 and insert 107 coupled in place and sealed. Retainer nut 103 is shown dotted as would not be visible in this view. Likewise, insert 107 is not visible in this view and is shown dotted. The threads of insert 107 are covered by cap element 109 in this view. Washers 102 and 108 are shown sealed to closure 104.

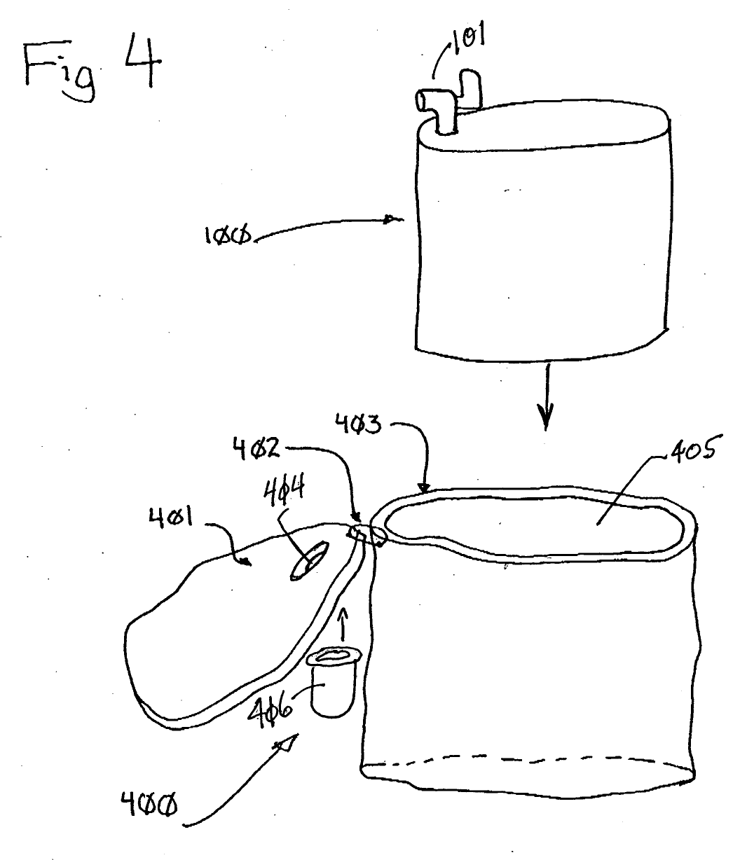

FIG. 4 illustrates an insulating sleeve 400 according to embodiments of the present invention used to insulate dispensing container unit 100 in thermally sensitive applications. Insulating sleeve 400 comprises insulating sleeve body 403, an insulating cover flap 401, and a combination cover hinge and retention element 402. Insulating sleeve body 403 is configured to be compatible with the shape of liquid dispensing container unit 100. Insulating sleeve body 403 has an opening 405 for inserting liquid dispensing container unit 100. Hinge and retention element 402 enables cover flap 401 to pivot into place to cover and insulate the top portion of liquid dispensing container unit 100 not covered by insulating sleeve body 403. Cover flap 401 may have an optional clearance hole 404 for accessing a spout valve (e.g. spout valve 101). In this case, an optional boot cover 406 may be used to slip over the spout valve (e.g. spout valve 101) and couple to cover flap 401 (e.g., with Velcro® fasteners). Using boot cover 406, insulating cover flap 401 does not have to be rotated open to extract liquid material from liquid dispensing container unit 100 thus reducing heat loss or heat uptake.

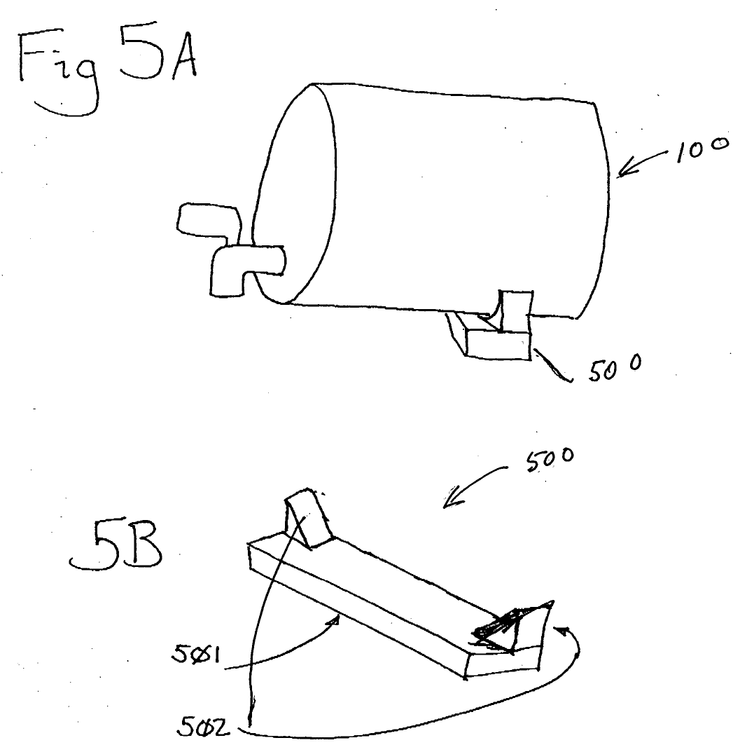

FIG. 5A illustrates a liquid dispensing container unit 100 in a dispensing orientation using a brace 500. FIG. 5B shows brace 500 comprising a block 501 and two triangle shaped support elements 502. In one embodiment, the triangle shaped elements 502 are coupled to block 501 on each end as shown. Block 501 and triangle shaped support elements 502 may be made of a semi rigid flexible material (e.g., cell polyethylene foam) that is sufficiently compliant to conform to dispensing container unit 100 while having a high enough durometer to support dispensing container unit at a predetermined and desired angle for maximum liquid material dispensing. In another embodiment, the triangle shaped support elements 502 are substantially rigid with interface surfaces that are shaped to conform to the contour of dispensing container unit 100 at their points of contact. Other shapes for the support elements 502 may be employed and are considered within the scope of the present invention.

Although the present invention and its advantages have been described in detail, it should be understood that various changes, substitutions and alterations can be made herein without departing from the spirit and scope of the invention as defined by the appended claims.

What is claimed is:

1. An insulating system for a container having a container body with walls extending between a closed end and an open end directly opposing the closed end and a removable closure configured to couple to the walls of the container body to seal the open end, the removable closure having a first opening configured to receive and retain a cap for sealing the first opening, the insulating system comprising:
a removable, insulating boot for covering outside surfaces of the container body while providing a first boot opening for accessing the first opening in the removable closure; and
an insulating cover configured to couple to the insulating boot and cover the first boot opening.

2. The system of claim 1, wherein the insulating boot comprises
a body section configured to fit over and conform to the container body;
a bottom section coupled to the body section and covering the closed end of the container body; and
a top section that is hingedly coupled to the body section allowing the top section to be hinged opened exposing the removable closure and allowing the top section to be hinged closed and coupled to the body section to cover and thermally insulate the top section.

3. The system of claim 1, wherein the bottom section of the insulating boot is removeably coupled to the body section.

4. The system of claim 2 wherein the first boot opening is in the top section of the insulating boot.

5. The system of claim 2, wherein the removable closure has a second opening configured to receive a spout valve that allows controlled removal of liquid from the container.

6. The system of claim 5, wherein the top section of the insulating boot has a second boot opening for accessing the spout valve.

7. The system of claim 6, further comprising an insulating cup configured to fit over the spout valve and couple to the top section of the insulating boot thereby covering the spout valve and the second boot opening.

8. The system of claim 2, wherein the container body has a second opening configured to receive a spout valve that allows controlled removal of liquid from the container.

9. The system of claim 8, wherein the body section of the insulating boot has a second boot opening for accessing the spout valve.

10. The system of claim 9, further comprising an insulating cup configured to fit over the spout valve and couple to the body section of the insulating boot thereby covering the second boot opening.

11. A liquid container system for storing and transporting thermally sensitive liquid comprising:
a container having a container body with walls extending between a closed end and an open end directly opposing the closed end;
a removable closure configured to couple to the walls of the container body to seal the open end, wherein the removable closure has a first opening configured to receive and retain a cap for sealing the first opening;
a removable, insulating boot for covering outside surfaces of the container body while providing a first boot opening for accessing the first opening in the removable closure; and
an insulating cover cap configured to couple to the insulating boot and cover the first boot opening.

12. The system of claim 11, wherein the insulating boot comprises
a body section configured to fit over and conform to the container body;
a bottom section coupled to the body section and covering the closed end of the container body; and
a top section that is hingedly coupled to the body section allowing the top section to be hinged opened exposing the removable closure and allowing the top section to be hinged closed and coupled to the body section to cover and thermally insulate the top section.

13. The system of claim 11, wherein the bottom section of the insulating boot is removeably coupled to the body section.

14. The system of claim 12 wherein the first boot opening is in the top section of the insulating boot.

15. The system of claim 12, wherein the removable closure has a second opening configured to receive a spout valve that allows controlled removal of liquid from the container.

16. The system of claim 14, wherein the top section of the insulating boot has a second boot opening for accessing the spout valve.

17. The system of claim 15, further comprising an insulating cup configured to fit over the spout valve and couple to the top section of the insulating boot thereby covering the spout valve and the second boot opening.

18. The system of claim 12, wherein the container body has a second opening configured to receive a spout valve that allows controlled removal of liquid from the container.

19. The system of claim 18, wherein the body section of the insulating boot has a second boot opening for accessing the spout valve.

20. The system of claim 19, further comprising an insulating cup configured to fit over the spout valve and couple to the body section of the insulating boot thereby covering the second boot opening.
